(19) United States
(12) Patent Application Publication
(10) Pub. No.: US 2007/0299748 A1
(43) Pub. Date: Dec. 27, 2007

(54) System and method for analyzing service loss within a rotable supply chain

(76) Inventors: Bret Allen Shorter, Morton, IL (US); Cassandra Lea Osborne, East Peoria, IL (US); Amy Michelle Ahlers, Morton, IL (US); Jennifer Katherine Aspinall, East Peoria, IL (US); Andrew James Graves, Tremont, IL (US); Christopher Paul Kopinski, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/642,534

(22) Filed: Dec. 21, 2006

Related U.S. Application Data
(60) Provisional application No. 60/816,313, filed on Jun. 26, 2006.

(51) Int. Cl. G06Q 10/00

(52) U.S. Cl. 705/28

(57) ABSTRACT

A method for analyzing service loss in a rotable supply chain includes receiving, in an inventory management system, an exchange sales order associated with a rotable part. The method also includes establishing a scheduled ship date associated with the exchange sales order. One or more supply chain events associated with an item on an exchange sales order are created, wherein the one or more supply chain events are indicative of the status of the item on an exchange sales order. A cause of service loss associated with the exchange sales order is determined based on the one or more supply chain events if the exchange sales order is not fully shipped by the scheduled ship date. A report is generated summarizing the cause of service loss associated with the exchange sales order.

This application claims priority to and the benefit of the filing date of U.S. Provisional Patent Application No. 60/816,313, filed Jun. 26, 2006, which is herein incorporated by reference in its entirety.

### TECHNICAL FIELD

The present disclosure relates generally to inventory management systems for supply chain management systems and, more particularly, to systems and methods for analyzing service loss within a rotable supply chain.

### BACKGROUND

Supply chain management is integral to any organization that relies on high-volume production, sale, and distribution of parts to customers. Supply chain management provides processes and methods that enable organizations to control the flow of goods and services associated with a particular product or service for sale. An organization's performance often depends on its ability to adjust aspects associated with its supply chain management processes in order to meet customer needs more effectively. Thus, businesses that can effectively modify their supply chain to more effectively meet customer expectations while controlling manufacturing, distribution, and storage costs may have an increased market position over competitors with less sophisticated supply chain management capabilities.

In an effort to increase supply chain management efficiency, many organizations have implemented automated processes for managing inventory levels, raw material acquisition, and manufacturing schedules to meet a customer demand level. While these systems may be effective for maintaining inventory levels sufficient to meet a future demand, they may not be able to identify and/or correct problems within the supply chain that cause a failure to fulfill a customer service expectation. Moreover, because most conventional systems are only adapted to monitor inventory levels and service schedules associated with the manufacture of new parts, these conventional processes may be insufficient for managing inventory associated with used or rotable part exchange programs where material inventory and product availability schedules vary based on aspects of the core material inventory, such as, for example, a quantity of core material in inventory, the usability of the core material, and the timeliness with which customers return used core material to the rotable supply chain. Thus, in order to more efficiently and appropriately manage inventory within a supply chain environment, a system analyzing service loss for both new and rotable inventory within a supply chain may be required.

One system that has been developed to ensure order fulfillment and resolve certain conflicts associated with product variability is described in U.S. patent application Publication No. 2002/0188499 to Jenkins et al. The '499 publication describes a process for determining requirements of a supply chain order, checking a supply chain model to determine the availability of the order for a desired time, and, if the order is unavailable for the desired time, modifying the supply chain to fulfill the order. The supply chain model may be modified to reflect the changes made to the supply chain. The system of the '499 publication may be configured to create a supply chain model based on inventory trends, and adjust the model as-needed to meet customer demands and, in certain situations, to resolve inventory conflicts in real-time.

Although the process of the '499 publication may be adapted to model and, in some cases, predict supply chain trends, it may do nothing to determine one or more causes of loss in customer service associated with the supply chain. For example, because the system of the '499 publication does not create inventory events associated with customer orders in order to track the procession of the order through a repair/overhaul process chain, it cannot analyze the process chain events to identify those events or facilities that cause the loss of customer service. As a result, should the system of the '499 not meet a customer request for a product, the system is not able to identify or track causes associated with service loss, which may be instrumental in determining and maintaining customer service levels in inventory management environments.

The presently disclosed system and method for analyzing service loss within a rotable supply chain are directed to overcoming one or more of the shortcomings set forth above.

### SUMMARY OF THE INVENTION

In accordance with one aspect, the present disclosure is directed toward a method for analyzing service loss in a rotable supply chain. The method may include receiving, in an inventory management system, an exchange sales order associated with a rotable part. The method may also include establishing a scheduled ship date associated with the exchange sales order. One or more supply chain events associated with an item on the exchange sales order may be created, wherein the one or more supply chain events are indicative of the status of the item on the exchange sales order. A cause of service loss associated with the exchange sales order may be determined based on supply chain events or predefined rules associated with the item on the exchange sales order if the exchange sales order is not fully shipped by the scheduled ship date. A report may be generated summarizing the cause of service loss associated with the exchange sales order.

According to another aspect, the present disclosure is directed toward a method for analyzing service loss in a rotable supply chain. The method may include receiving, in an inventory management system, an exchange sales order associated with a rotable part. The method may also include establishing a scheduled ship date associated with the exchange sales order. One or more supply chain events associated with an item on the exchange sales order may be created, wherein the one or more supply chain events are indicative of the status of the item on the exchange sales order. A cause of service loss associated with the exchange sales order may be determined based on supply chain events or predefined rules associated with the item on the exchange sales order if the exchange sales order is not fully shipped by the scheduled ship date. An operational aspect associated with a rotable supply chain may be adjusted based on the cause of service loss. The operational aspect may be associated with any segment of inventory management, purchasing and expediting, records management, warehouse and quality management, transportation management, or human resources.

In accordance with yet another aspect, the present disclosure is directed toward a system for analyzing service loss in a rotable supply chain. The system may include a processor, an input device communicatively coupled to the processor and configured to receive data associated with inventory management for a supply chain, and an output device communicatively coupled to the processor and configured to output data from the processor. The processor may be configured to receive, in an inventory management system, an exchange sales order associated with a rotable part. The processor may also be configured to establish a scheduled ship date associated with the exchange sales order. The processor may be further configured to create one or more supply chain events associated with an item on the exchange sales order, wherein the one or more supply chain events are indicative of the status of the item on the exchange sales order. The processor may also be configured to determine a cause of service loss associated with the exchange sales order based on supply chain events or predefined rules associated with the item on the exchange sales order if the exchange sales order is not fully shipped by the scheduled ship date. The processor may also be configured to generate a report summarizing the cause of service loss associated with the exchange sales order.

### BRIEF DESCRIPTION OF THE DRAWINGS

FIG. 1 illustrates an exemplary supply chain management environment in which processes and methods consistent with the disclosed embodiments may be implemented;

FIG. 2 provides a schematic illustration of an exemplary inventory management system in accordance with certain disclosed embodiments;

FIG. 3 illustrates a flowchart depicting an exemplary disclosed method for analyzing service loss within a rotable supply chain;

FIG. 4 illustrates an exemplary diagram depicting rotable material turn around time within a rotable supply chain; and

FIG. 5 illustrates exemplary material flow processes and related transactions associated with a rotable inventory management system.

### DETAILED DESCRIPTION

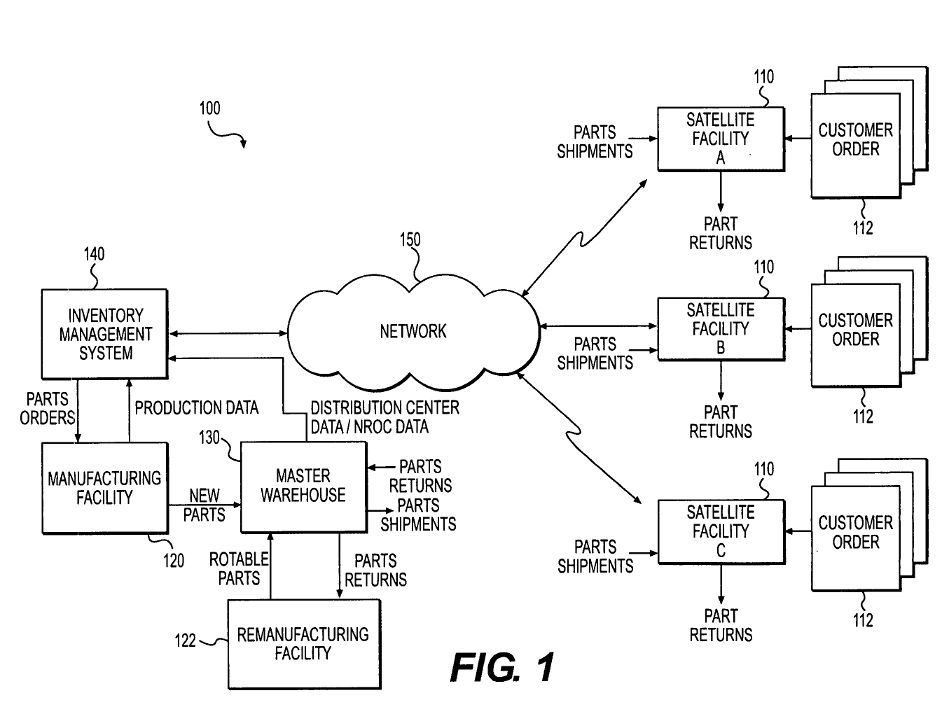

FIG. 1 illustrates an exemplary supply chain management environment 100 in which methods and processes consistent with the disclosed embodiments may be implemented. Supply chain management, as the term is used herein, refers to any process or system involved in the production, shipment, distribution, sale, tracking, or storage of goods between or among raw material suppliers, distributors, manufacturers, retailers, and customers. Furthermore, supply chain management may include quality control processes, logistics management processes, inventory management processes, and/or account management processes, associated with the flow of data and materials within a particular supply chain. According to one embodiment, and as illustrated in the FIG. 1, supply chain management environment 100 may include systems associated with one or more satellite facilities 110, one or more manufacturing (and/or remanufacturing) facilities 120, one or more master warehouses 130, and an inventory management system 140. These systems may be communicatively coupled to one or more other systems associated with supply chain management environment 100 via communication network 150. It is contemplated that, although the present disclosure may describe certain processes and functions as being performed by one or more facilities or warehouses described above, these processes and functions may be performed manually (e.g., by personnel associated with the respective facility) and/or electronically, by one or more computer systems associated with a respective facility.

Satellite facility 110 may include a computer system for receiving, analyzing, tracking, updating, and/or processing customer orders 112. For example, satellite facility 110 may be associated with a retail or wholesale parts facility responsible for receiving and filling customer part orders; monitoring and maintaining local inventory levels; collecting and managing part returns, including new part returns, core returns, used part returns, etc.; filling part exchange requests; and/or receiving part shipments from one or more other facilities (e.g., manufacturing/remanufacturing facilities, distribution centers, regional warehouse storage facilities, and/or other part supplier facilities). According to one embodiment, a computer system associated with satellite facility 110 may monitor, record, and analyze data associated with each type of transaction (sales, returns, exchanges, core deposits, repairs, re-certifications, etc.) associated with a customer order 112. This data may be periodically or continuously uploaded into a central backend system, such as inventory management system 140.

Master warehouse 130 may include a computer system for monitoring and managing inventory associated with one or more distribution centers. For example, master warehouse 130 may be adapted to monitor and track the receipt of parts (e.g., new parts, rotable parts, etc.) from a manufacturing plant, as well as the shipment and distribution of parts from the distribution center. Rotable parts, as the term is used herein, refers to any part that is manufactured in such a way that the part (or a component thereof) may be repaired, remanufactured, or overhauled in such a way so as to reset at least a portion of the usable life thereof. According to one embodiment, rotable parts may be purchased as part of a rotable part exchange program, where customers receive a remanufactured, repaired, and/or recertified rotable part. When the part needs replacing, the customer may return the part for a refund of a core deposit and exchange it for a replacement part. The returned part may be remanufactured and/or repaired to recondition the part into a saleable rotable part.

Inventory management system 140 may include an electronic system configured to monitor and record inventory data associated with supply chain environment 100. For example, the inventory management system 140 may be communicatively coupled to one or more of satellite facility 110, manufacturing facility 120, and master warehouse 130. Inventory management system 140 may collect inventory data associated with each respective system, monitor and control the flow of inventory between or among each system, and adapt supply chain resources to ensure the appropriate operation of supply chain environment 100.

According to one embodiment, inventory management system 140 may receive data associated with a satellite facility from a corresponding satellite facility 110 and store the data in memory for future analysis. For example, inventory management system 140 may receive customer orders from a satellite facility. Customer orders may include, among other things, information identifying a requested part, a desired quantity associated with a requested part, a desired part condition associated with a requested part (e.g., new, re-certified, repaired, remanufactured, etc.) and information that may correspond to a return transaction associated with the customer order (e.g., whether the order includes an accompanying core return, rental return, repair and/or overhaul part return). This information may be stored in an inventory management database associated within inventory management system 140 for future analysis.

Inventory management system 140 may be adapted to monitor, analyze, and record data received from manufacturing facility 120 (via a computer system associated therewith) and provide commands to manufacturing facility 120 for adjusting productivity levels of the manufacturing plant to meet customer demand. It is contemplated that inventory management system 140 may adjust the levels associated with both new and rotable parts. For instance, inventory management system 140 may reduce the level of production for new parts associated with a particular part number based on a decrease in demand for new parts. Alternatively and/or additionally, inventory management system 140 may increase the level of remanufactured parts from core materials, based on an increase in customer demand for remanufactured parts.

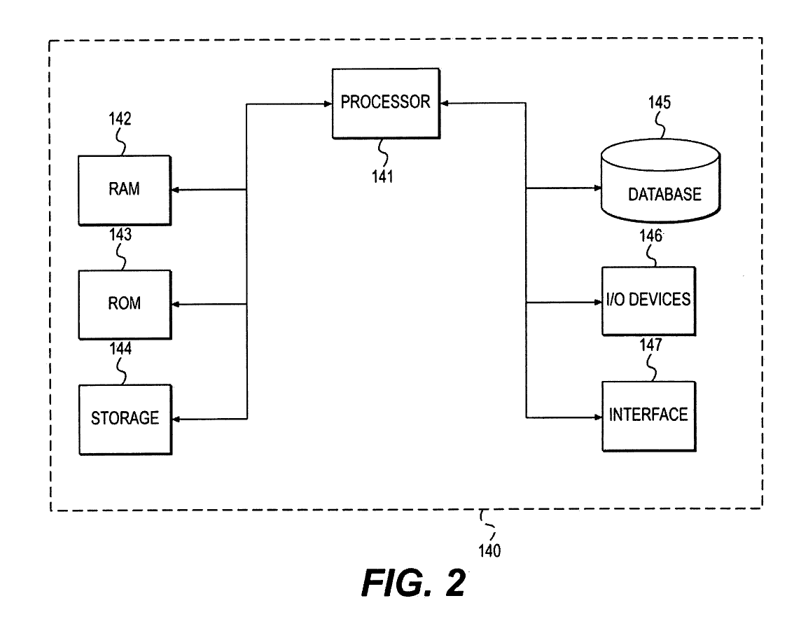

Inventory management system 140 may include any type of processor-based system on which processes and methods consistent with the disclosed embodiments may be implemented. For example, as illustrated in FIG. 2, inventory management system 140 may include one or more hardware and/or software components configured to execute software programs, such as software for managing supply chain environment 100, inventory monitoring software, or inventory transaction software. For example, inventory management system 140 may include one or more hardware components such as, for example, processor 141, a random access memory (RAM) module 142, a read-only memory (ROM) module 143, a storage system 144, a database 145, one or more input/output (I/O) devices 146, and an interface 147. Alternatively and/or additionally, inventory management system 140 may include one or more software components such as, for example, a computer-readable medium including computer-executable instructions for performing methods consistent with certain disclosed embodiments. It is contemplated that one or more of the hardware components listed above may be implemented using software. For example, storage 144 may include a software partition associated with one or more other hardware components of inventory management system 140. Inventory management system 140 may include additional, fewer, and/or different components than those listed above. It is understood that the components listed above are exemplary only and not intended to be limiting.

Processor 141 may include one or more processors, each configured to execute instructions and process data to perform one or more functions associated with inventory management system 140. As illustrated in FIG. 2, processor 141 may be communicatively coupled to RAM 142, ROM 143, storage 144, database 145, I/O devices 146, and interface 147. Processor 141 may be configured to execute sequences of computer program instructions to perform various processes, which will be described in detail below. The computer program instructions may be loaded into RAM for execution by processor 141.

RAM 142 and ROM 143 may each include one or more devices for storing information associated with an operation of inventory management system 140 and/or processor 141. For example, ROM 143 may include a memory device configured to access and store information associated with inventory management system 140, including information for identifying, initializing, and monitoring the operation of one or more components and subsystems of inventory management system 140. RAM 142 may include a memory device for storing data associated with one or more operations of processor 141. For example, ROM 143 may load instructions into RAM 142 for execution by processor 141.

Storage 144 may include any type of mass storage device configured to store information that processor 141 may need to perform processes consistent with the disclosed embodiments. For example, storage 144 may include one or more magnetic and/or optical disk devices, such as hard drives, CD-ROMs, DVD-ROMs, or any other type of mass media device.

Database 145 may include one or more software and/or hardware components that cooperate to store, organize, sort, filter, and/or arrange data used by inventory management system 140 and/or processor 141. For example, database 145 may include historical data such as, historic inventory fluctuations and/or past customer order data. Trends may be recorded and analyzed to adjust one or more aspects associated with an inventory control process, which may potentially reduce inventory management errors, and/or product over- or under-stocking. It is contemplated that database 145 may store additional and/or different information than that listed above.

I/O devices 146 may include one or more components configured to communicate information with a user associated with inventory management system 140. For example, I/O devices may include a console with an integrated keyboard and mouse to allow a user to input parameters associated with inventory management system 140. I/O devices 146 may also include a display including a graphical user interface (GUI) for outputting information on a monitor. I/O devices 146 may also include peripheral devices such as, for example, a printer for printing information associated with inventory management system 140, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 147 may include one or more components configured to transmit and receive data via a communication network, such as the Internet, a local area network, a workstation peer-to-peer network, a direct link network, a wireless network, or any other suitable communication platform. For example, interface 147 may include one or more modulators, demodulators, multiplexers, demultiplexers, network communication devices, wireless devices, antennas, modems, and any other type of device configured to enable data communication via a communication network.

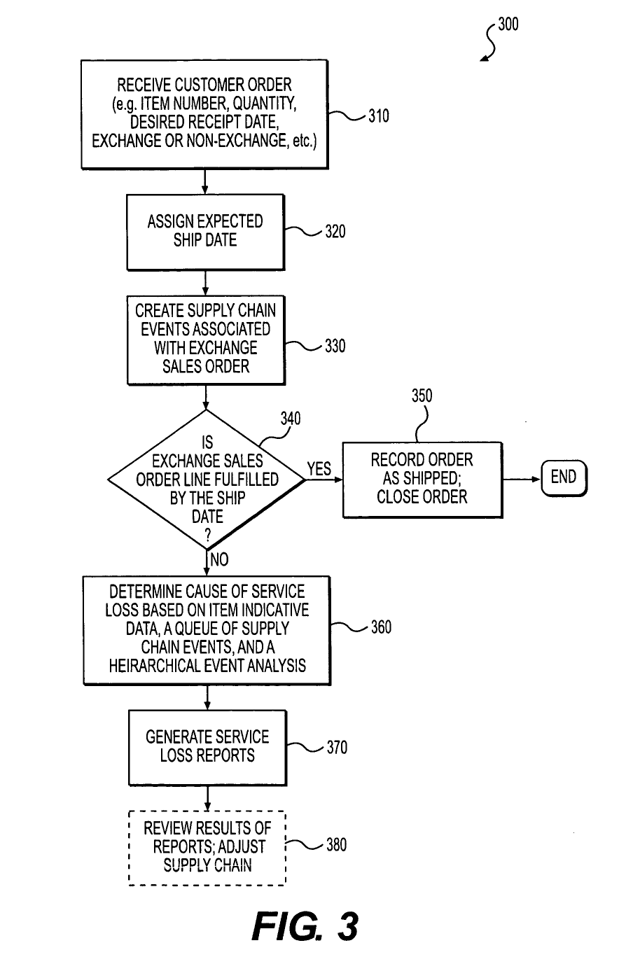

Inventory management system 140 may include one or more software applications for determining the causes of service loss and identifying patterns of service loss associated with rotable inventory within a supply chain. For example, service loss, as the term is used herein, refers to any instance where a customer requirement of the supply chain is not met. Service loss may include any failure of the supply chain resulting in a failure to fulfill a rotable part order by a predetermined (e.g., contracted) date. Inventory management system 140 may include a software application that tracks data (either real-time or by batch in predetermined intervals) associated with a rotable supply chain, monitors the data to identify failures in meeting customer orders, and determines the cause of these failures. According to one embodiment, the software may generate reports that summarize the service loss analysis and provide recommendations for mitigating the effects of service loss. FIG. 3 provides a flowchart 300 illustrating an exemplary disclosed method for analyzing service loss within a rotable supply chain that may be performed by inventory management system 140 and/or software associated therewith.

As illustrated in FIG. 3, inventory management system 140 may receive exchange sales orders from one or more customers participating in a part exchange program (Step 310). Exchange sales order, as the term is used herein, refers to a customer sales order for a rotable part as part of a used part exchange program. This may include an entire sales order, a single sales order line, or individual pieces on a sales order line. This data may be collected by inventory management system 140 and/or software associated with an inventory database, a centralized order database, or any other system configured to receive customer orders. This data may be received automatically and/or in response to a request for data provided by inventory management system 140.

As explained, exchange sales orders typically include customer returns of core parts in exchange for a remanufactured rotable part. Accordingly, the core parts may be inspected for wear and to determine whether the core material can be remanufactured to produce saleable material. In some cases, customers replace parts based on manufacturer's suggested scheduled maintenance, component failures, service bulletins or recalls. As a result, returned parts often require varying degrees of repair to return them back to saleable status. For example, some returned parts, particularly those that may have been provided to a customer as a substitute or rental part, may only need minor repairs prior to being recertified as saleable material. Alternatively, some parts may need to be completely overhauled to restore the part back to saleable material.

According to one embodiment, when a customer returns a used part, the part may be inspected to estimate an amount of time that the part may still be used before its useable life expires. If the remaining useable life is below a predetermined threshold or other extensive repairs are needed, the part may be classified as an overhaul order, indicating that the part must be torn down to its core components and completely remanufactured before entering the exchange pool as saleable material. If, on the other hand, the remaining useable life exceeds the predetermined threshold or minor repairs are needed, the part may be classified as a repair order, indicating that the part may only require repair to return it to saleable status. Repair orders often require substantially less time and fewer resources to restore the part to saleable status, when compared with overhaul orders. By classifying the status and condition of returned parts, a rotable supply chain may process repair and overhaul orders individually. As a result, repair parts may be returned to the exchange pool faster and with less expense than parts that require complete overhaul.

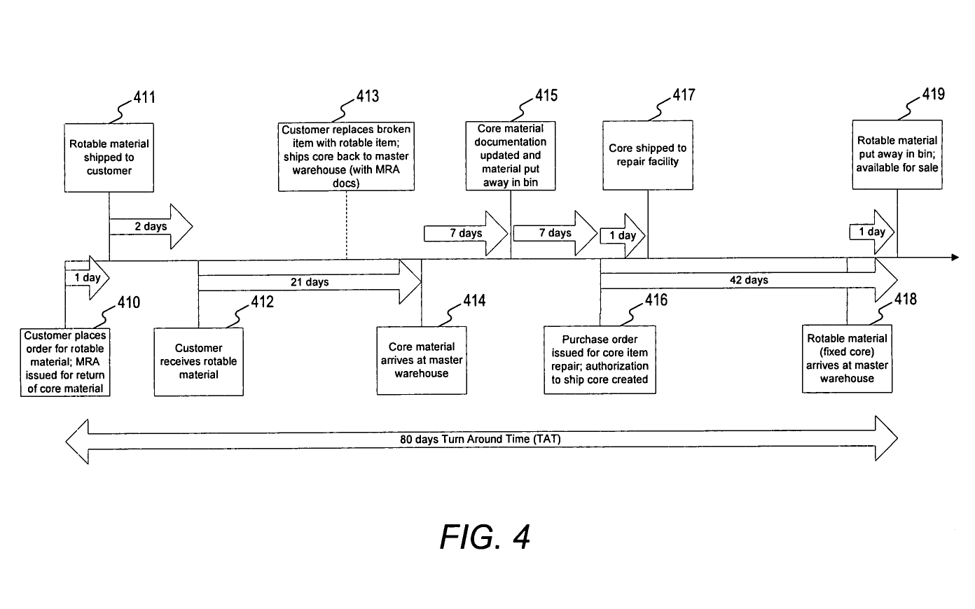

Upon receipt of the exchange sales order, inventory management system 140 may establish a scheduled ship date based on customer priority and operations performance standards (Step 320). The assigning of the order shipment date sets the expected performance limits on the first step in the exchange order timeline for the rotable item upon which further steps are based. An exemplary exchange timeline is illustrated in FIG. 4. As illustrated in the example of FIG. 4, the exchange sales order timeline may include one or more activities that may be carried out from the time a customer places an exchange sales order to the time that a rotable product associated with the exchange sales order is available for sale. As shown, a typical exchange order may be opened when a customer places an exchange sales order at a facing facility (410) (such as satellite facility 110 or master warehouse 130). The rotable material may then be shipped (411) to the customer that, upon receipt of the rotable material (412), is allotted a predetermined amount of time to ship the replaced part (core material) back to master warehouse 130 (Step 413).

Upon receiving the core material in master warehouse 130 (Step 414), inventory management system 140 may be updated to document the receipt of the core material. The core material may be stocked for future repair/remanufacture (Step 415). Once a purchase order is issued for a core repair/remanufacture (Step 416), the core is shipped to a repair facility (Step 417), where the core undergoes a repair/remanufacture process to return the rotable item to saleable status. Upon completion of the repair, the repair facility may ship the rotable item (now in sellable repair or overhaul condition) back to the master warehouse (Step 418), where it is stocked to fill a future exchange order (Step 419).

As illustrated in FIG. 4, in order to accurately plan for the replenishment of rotable material within the rotable supply chain, certain activities associated with the rotable material may be allotted a time limit. These time limits represent typical time periods associated with the particular event within the rotable supply chain. Supply chain event, as the term is used herein, refers to a particular condition or activity associated with one or more items on an exchange sales order. Supply chain events are created to reflect the status of the item within the supply chain. For example, when a purchase order is placed to obtain additional rotable material for the supply chain, inventory management system 140 may create an open purchase order event (e.g., event code “ONPO”). If the purchase order is later changed by a supplier, inventory management system 140 may modify the purchase order according to the supplier request and write an event to document the change (e.g., event code “UPPO”). When the order arrives at master warehouse 130, inventory management system 140 may generate a receipt event (e.g., event code “RCPT”) associated with the purchase order. The time periods shown in FIG. 4 are exemplary only and not intended to be limiting. Thus, the time periods may be customized for a particular supply chain without departing from the scope of the present disclosure. It is also contemplated that additional, fewer, and/or different supply chain events may be utilized in the rotable material timeline than those shown in the example of FIG. 4.

Once the scheduled ship date has been established, the inventory management system 140 will begin to monitor the success or failure of the product shipment by creating one or more supply chain events associated with different stages of the fulfillment process (Step 330). When the order is shipped from master warehouse 130, inventory management system 140 may generate a ship event associated with the exchange sales order (e.g., event code “SHIP”). If the complete shipment of the material occurs after the scheduled ship date, inventory management system 140 may generate a backorder event (e.g., event code “BACK”), indicating that the exchange sales order is backordered. If the backorder event is due to the aforementioned purchase order change request by the supplier, inventory management system may identify the backorder event accordingly (e.g., event code “BACK” with event reason “UPPO”). It is contemplated that the events described above serve to provide examples of typical events associated with an exchange sales order and other aspects of a rotable supply chain. Additional and/or different events may be used to analyze the root causes for a backorder, for example, when a substitute part is provided (due to part supercession), when a part is placed in a supply bin, when a purchase order or customer return order is overdue, when a part is released for shipment but not actually shipped by a warehouse, when an order line is not forecastable (due, for example, to a newly inventoried part), when a gross requirement quantity is decreased, or any other event associated with a supply chain. Additionally, item characteristics may be used to analyze the root cause for a backorder, for example, if the inventory management team has been directed by the account managers to not stock a particular part in the warehouse, if the item has future forecast provided by account managers, if the item does not have sufficient demand history to generate a reliable forecast or any other item indicative characteristic. Accordingly, the events described in the examples above are exemplary only and not intended to be limiting.

The event codes created by inventory management system 140 may be stored in an event queue, which is examined periodically (e.g., at the end of each shift, daily, weekly, etc.) to determine why any of the exchange sales orders failed to ship by the scheduled ship date. This may be accomplished by analyzing one or more of the events contained in the event queue based on a predetermined hierarchy of events and item indicative data associated with one or more rotable parts. Item indicative data may include any data associated with the rotable part that may affect the ability to fully ship the exchange sales order by the scheduled ship date. For example, if the part is too new to the product inventory (for example, less than 24 months) there may not be enough forecast data to properly and adequately forecast the demand for the part. As a result, these parts may be categorized separately in service loss reporting until the part remains active for the prescribed number of forecast periods.

The hierarchy of events may be a user-defined event list that, when compared with the event queue, detects the presence of an event which identifies a potential cause of the service loss. For example, the hierarchy of events may be customized by a user to first identify events associated with a particular activity (e.g., shipping, repair, inspection, etc.) or facility (e.g., facing, warehouse, repair, etc.). Alternatively and/or additionally, the hierarchy may be arranged to identify the more common events that may cause service loss (e.g., event codes related to items released for shipping, but that have not been shipped; event codes associated with repair delay; event codes associated with purchase order delay, etc.). According to one embodiment, the hierarchy of events may be divided into multiple tiers, each tier corresponding to events associated with a particular facility. However, users may customize the hierarchy to most efficiently identify service loss associated with their respective supply chain. Accordingly, the hierarchy of events described herein is exemplary only and not intended to be limiting. Particular events associated with the event hierarchy are described below.

If the exchange sales order is completely shipped by the scheduled ship date (Step 340: Yes), inventory management system 140 may record that the exchange sales order has been shipped and forego service loss analysis processing for that order (Step 350). If the exchange sales order is not fully shipped by the scheduled ship date (Step 340: No), inventory management system 140 may analyze supply chain events associated with the exchange item to identify one or more events that did not conform to the expected exchange time line, planning events, or item indicative events (see FIG. 4).

The identified supply chain events may be analyzed to determine a cause of service loss associated with the exchange sales order (Step 360). The loss analysis may include analyzing the one or more supply chain events created by inventory management system 140. Additionally, the loss analysis may include analyzing each event or rule based on the predetermined hierarchy. For example, the hierarchy may specify a rule that detects when an exchange sales order was released for shipment on time, but not shipped by the warehouse facility (e.g., reason code “RLSD”) prior to the scheduled ship date. As previously explained, the analysis hierarchy analyzes multiple event codes held in the event queue associated with one or more rotable items. Similarly, the analysis hierarchy may include one or more predefined rules that, while not attributed to a particular event or activity, may be defined to identify particular conditions associated with an exchange sales order item. As in the “RLSD” example above, these rules may arise or become active when a particular exchange sales order item conforms to a predetermined condition set (e.g., exceeds a ship time, etc.).

The predetermined event standards may include acceptable time periods for comparison with each event. Inventory management system 140 may flag one or more events that, when compared with the standard, indicates unexpected or non-conforming results. For example, a repair event (all material movements and transactions from the time the rotable item is sold to the time the returned core will be sellable product) associated with a particular part may include a plurality of subtasks. Each subtask may be allotted a particular time limit for completion. If the repair event exceeds a scheduled repair duration, each subtask may be compared with the checklist to identify any non-conformity associated with the subtask. For instance, a particular repair event includes a plurality of subtasks, one of which is the return of a core from a customer. If these core returns are not returned by the due date (for example due to a customer taking longer to extract the core from its machine), the standards may identify this as a non-conforming item, which may eventually be identified as a cause of service loss associated with a future exchange sales order for that rotable item.

When service loss occurs, inventory management system 140 may sift through all available events for the ordered item based on the user-defined hierarchy. Some systems will look at the available events and predefined rules in the following order (and choose the first applicable event): sales order line level (order line shipped late, non-forecastable order due to sales promotion or chose not to ship available material of another condition) for repair/overhaul/new material, events for the item at the customer facing facility for repair/overhaul/new material (pick exceptions, material in blocked location, etc), events for the item at the sourcing (master) facility for repair/overhaul/new material (overdue purchase orders), core return events within the entire network, and then item indicative data is analyzed to determine if a policy decision was an applicable cause (ex. new item or client policy not to stock/replenish item). If no other reason can be found, a default reason is assigned to the reason (e.g., “inventory management system loss”). The events at each level can be aggregated to the following categories for reporting: transportation delay, warehouse management delay, vendor delay, and inventory management loss.

According to one embodiment, inventory management system 140 may generate multiple service loss reports summarizing service loss events (Step 370). A service loss report may identify each instance of service loss associated with a particular customer and may be provided to customers of the exchange program. Alternatively and/or additionally, a service loss report may identify sources of service loss associated with a particular facility associated with the supply chain or a particular rotable part. This report may be provided to one or more systems, facilities, or personnel associated with the supply chain, and may be used to mitigate the causes of service loss associated with the rotable exchange program. According to one aspect, service loss reports may include recommendations for reducing causes of service loss associated with the exchange program.

Recommendations for reducing causes of service loss may include, for example, recommendations for adjusting lead-times and/or schedules associated with one or more exchange order processes (e.g., repair, vendor shipment, purchasing, etc.), recommendations for hiring additional warehouse personnel to meet shipping volume, recommendations for changing parts suppliers based on supplier performance, or any other type of recommendation that may mitigate or reduce service loss associated with the supply chain. Alternatively and/or additionally, recommendations may also include suggestions for modifying internal inventory management processes such as, for example, recommendations for adjusting safety stock levels, demand forecasts, raw material quantities, gross requirements, or any other internal inventory management process. Recommendations for reducing causes of service loss may be predetermined, based on a lookup table associated with a particular reason code. Alternatively and/or additionally, recommendations may be derived from historical service loss data (previous service loss solutions stored in a service loss matrix associated with inventory management system). For example, it is contemplated that service loss statistics may be recorded in a service loss database. Once the service loss has been resolved, the solution or remedy may be stored in the database. Subsequently, when a service loss reason code is encountered, inventory management analysts may search for recommendations corresponding to the particular reason code, and provide these recommendations in the service loss report.

Once the cause of service loss has been identified, inventory management analysts or supply chain personnel may adjust one or more operational aspects associated with the supply chain (Step 380) to mitigate the effect of the service loss on subsequent exchange sales orders. Operational aspects of the rotable supply chain may include, for example, adjustments to inventory levels, gross requirements, lead-times, forecast models, safety stock, shipping schedules, or any other type of process or system adjustment that may enable the supply chain to meet a target (e.g., contract) customer service level. Operational aspects of the rotable supply chain may be associated with any segment of inventory management, for example, modifications to purchasing and expediting procedures (such as increasing purchase levels and/or lead times), records management, warehouse and quality management, transportation management, or human resources (e.g., hiring additional personnel to expedite one or more inventory management tasks). For example, if inventory management system 140 determines that service loss is attributed to delay associated with a raw material vendor, an adjustment may be made to the purchasing and acquisition requirements associated with that vendor to ensure that sufficient raw materials are on-hand. This may include speaking with the vendor, searching for alternate vendors, or increasing purchasing lead-time for that particular vendor.

According to one embodiment, adjustments in supply chain operations may only be required if an overall service loss associated with the supply chain exceeds a predetermined (e.g., contracted or target) service loss level. For instance, if the overall service loss associated with an exchange program is within a predetermined acceptable range, adjustments in the rotable supply chain may not be required. However, service loss statistics may be recorded to identify recurring trends associated with particular part numbers and/or particular exchange events.

In some embodiments of this system, the order entry system and inventory management execution system may be controlled by separate entities. In these situations, service loss may be due to exchange sales orders that are not fully shipped on time when repair or overhaul material is unavailable in the customer facing facility, Out new material is available. Assuming that new material can be purchased to support the rotable pool, it is generally expected that new material should be made available for fulfilling exchange sales orders. In some cases, due to the potential large cost difference between new and repair/overhaul materials, the controller of the order entry system may choose to keep new material for a future non-exchange sales order rather than sacrifice that material at a lower value for an exchange sales order while allowing the exchange transaction to enter backorder status. Doing so would be acting contrary to the inventory management system philosophy and could result in the aforementioned loss reason being assigned.

In an effort to avoid service loss due to inventory managers not making new materials available to the exchange program, inventory management system 140 may be configured to track service loss for backorders that occur due to inventory manager decisions. For example, if an inventory manager does not allow new items to be ordered to supplement a rotable supply chain or when authorization for new material acquisition was given without ample time to prevent a backorder condition, inventory management system 140 may track these events in order to correctly attribute the service loss to a inventory replenishment plan policy decision.

According to another embodiment, inventory management system 140 may track situations where account management has directed that the inventory management system 140 should not order new material to satisfy rotable demand and an exchange sales order line for a repair condition is filled with new condition material. Thus, if a future order for a new part is overdue or backordered, the service loss may be attributed to the new part being used for rotable demand. In general, when a customer does not allow the purchase of new condition material to supplement the rotable pool for a specific item, and the customer fulfills exchange sales orders with new condition material for that item, an event written so that future service loss on the new condition item can be attributed to the “incorrect” use of the new material to satisfy the exchange sales order. Alternatively and/or additionally, if it is allowed to order new material to supplement the rotable pool, but that decision was made within the new part procurement lead time because there was not sufficient time to purchase additional new material, an event may be written so that the service loss is attributed to inventory replenishment plan policy decision.

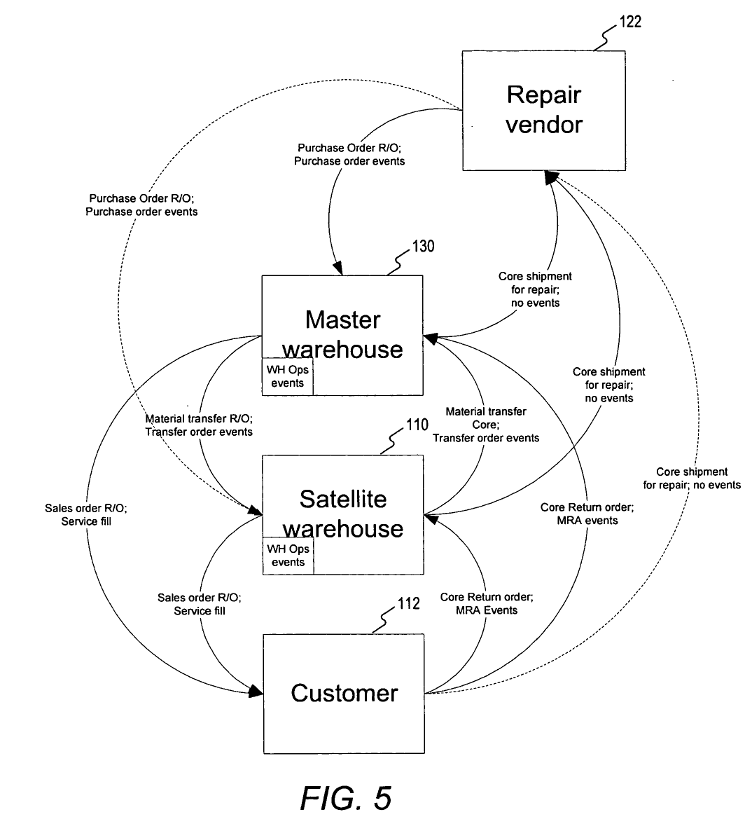

FIG. 5 provides an exemplary material flow process corresponding to typical rotable material movements within a supply chain. FIG. 5 illustrates exemplary transactions between each of the customer(s) 112, satellite warehouse(s) 110, master warehouse(s) 130, and repair vendor(s) 122. For example, when a customer places an exchange sales order for a rotable part, one or more of master warehouse 130 or satellite warehouse 110 may fill the exchange sales order and create a service fill event in the event queue, indicating that the customer has been shipped the requested part. As part of the exchange sales order, the customer may return rotable core material to one of master warehouse 130, satellite warehouse 10, and/or repair facility 122. A core return order may be provided to master warehouse 120 and/or satellite warehouse 110 to track the return of the core material (one or more Material Return Authorization (MRA) events may be created in association with the core return order). Depending upon the core material needs of the satellite 110 and master warehouses 130, the transfer of material between these facilities may enable surpluses and deficits associated with each facility to be appropriately remedied. With each material transfer, one or more transfer order events may be created, in order to track transfer orders and identify service loss due to transfer orders. Upon receipt and repair of the core material, repair vendor 122 may provide the saleable (repair or overhaul) materials to master warehouse 130 and satellite facility 110 as part of a purchase order. Accordingly, inventory management system 140 may create one or more purchase order events associated with the saleable goods to track the saleable material (and service loss associated therewith).

It is also contemplated that, if service loss occurs on a new part, inventory management system 140 may search events associated with the new material supply chain. In contrast, because repair and overhaul events typically involve new material supply chains, repair material supply chains, overhaul material supply chains, and core material supply chains, if service loss occurs on repair or overhaul condition exchange sales orders, inventory management system 140 will check events associated with each of new, repair, overhaul, and core supply chains.

### INDUSTRIAL APPLICABILITY

Although the disclosed embodiments are described in association with exchange programs for rotable parts, the disclosed system and method for analyzing service loss within a rotable supply chain described herein may by applicable to any environment where it may be desirable to identify and limit the effects of service loss on a supply chain. Specifically, the disclosed system and method for analyzing service loss may be adapted to isolate causes of service loss in a supply chain and correct one or more events contributing to service loss. As a result, systems and methods consistent with the disclosed embodiments may potentially increase the overall efficiency and profitability of any supply chain.

The presently disclosed system and method for analyzing service loss within a rotable supply chain may have several advantages. First, by providing a method to identify causes of service loss associated with a rotable supply chain, inventory management system 140 may enable organizations to efficiently isolate and correct problems associated with a rotable supply chain. Furthermore, because inventory management system 140 may be configured to provide information leading to adjustments of operational aspects associated with a supply chain based on service loss, it may provide organizations with an effective means for mitigating problems associated with the supply chain.

It will be apparent to those skilled in the art that various modifications and variations can be made to the disclosed system and method for analyzing service loss within a rotable supply chain. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for analyzing service loss in a rotable supply chain comprising:
receiving an exchange sales order associated with a rotable part;
establishing a scheduled ship date associated with the exchange sales order;
creating one or more supply chain events associated with an item on the exchange sales order, wherein the one or more supply chain events are indicative of the status of the item on the exchange sales order;
determining a cause of service loss associated with the exchange sales order based on the supply chain events or predefined rules associated with item on the exchange sales order if the exchange sales order is not fully shipped by the scheduled ship date; and
generating reports summarizing the cause of service loss associated with the exchange sales order.

2. The method of claim 1, further including determining a customer service level based on a total number of exchange sales orders received during the order period and a total number of exchange sales orders fully shipped by the scheduled ship date during the order period.

3. The method of claim 1, further including adjusting an operational aspect associated with a rotable supply chain based on the cause of service loss.

4. The method of claim 1, wherein determining the cause of service loss includes analyzing the one or more supply chain events according to a predetermined hierarchy of events.

5. The method of claim 4, wherein the predetermined hierarchy of events is user-configurable.

6. The method of claim 1, wherein generating the report includes generating the report in real-time or at a predetermined interval.

7. The method of claim 1, wherein the report includes recommendations for mitigating the cause of service loss associated with the exchange sales order.

8. A computer-readable medium for use on a computer system, the computer-readable medium including computer-executable instructions for performing the method of claim 1.

9. A method for analyzing service loss in a rotable supply chain comprising:
receiving an exchange sales order associated with a rotable part;
establishing a scheduled ship date associated with the exchange sales order;
creating one or more supply chain events associated with an item on an exchange sales order, wherein the one or more supply chain events are indicative of the status of the item on an exchange sales order;
determining a cause of service loss associated with the exchange sales order based on the one or more supply chain events if the exchange sales order is not fully shipped by the scheduled ship date; and
adjusting an operational aspect associated with a rotable supply chain based on the cause of service loss.

10. The method of claim 9, further including determining a customer service level based on a total number of exchange sales orders received during the order period and a total number of exchange sales orders fully shipped by the scheduled ship date during the order period.

11. The method of claim 9, wherein determining the cause of service loss includes analyzing the one or more supply chain events according to a predetermined hierarchy of events.

12. The method of claim 9, further including providing a service loss report summarizing the cause of service loss associated with the exchange sales order.

13. The method of claim 12, wherein providing the service loss report includes generating the report in real-time or at a predetermined interval.

14. The method of claim 12, wherein the report includes recommendations for mitigating the cause of service loss associated with the exchange sales order.

15. A computer-readable medium for use on a computer system, the computer-readable medium including computer-executable instructions for performing the method of claim 9.

16. A system for analyzing service loss in a rotable supply chain comprising:
a processor;
an input device communicatively coupled to the processor and configured to receive data associated with inventory management for a supply chain; and
an output device communicatively coupled to the processor and configured to output data from the processor;
wherein the processor is configured to:
receive an exchange sales order associated with a rotable part;
establish a scheduled ship date associated with the exchange sales order;
create one or more supply chain events associated with an item on an exchange sales order, wherein the one or more supply chain events are indicative of the status of the item on an exchange sales order;
determine a cause of service loss associated with the exchange sales order based on the one or more supply chain events if the exchange sales order is not fully shipped by the scheduled ship date; and
generate a report summarizing the cause of service loss associated with the exchange sales order.

17. The system of claim 16, further including determining a customer service level based on a total number of exchange sales orders received during the order period and a total number of exchange sales orders fully shipped by the scheduled ship date during the order period.

18. The system of claim 16, further including adjusting an operational aspect associated with a rotable supply chain based on the cause of service loss.

19. The system of claim 16, wherein determining the cause of service loss includes analyzing the one or more supply chain events according to a predetermined hierarchy of events.

20. The system of claim 16, wherein the report includes recommendations for mitigating the cause of service loss associated with the exchange sales order.
